(19) United States
(12) Patent Application Publication
(10) Pub. No.: US 2024/0203274 A1
(43) Pub. Date: Jun. 20, 2024

(54) Method And System For Assisting In The Avoidance Of An Incursion Onto A Runway By An Aircraft Taxiing On An Airfield

(71) Applicant: Airbus Operations SAS, Toulouse (FR)

(72) Inventors: Emilie Claudel, Toulouse (FR); Isabelle Sentissi, Toulouse (FR); Louise Faure, Toulouse (FR)

(73) Assignee: Airbus Operations SAS, Toulouse (FR)

(21) Appl. No.: 18/535,224

(22) Filed: Dec. 11, 2023

(30) Foreign Application Priority Data
Dec. 16, 2022 (FR) 2213611

(51) Int. Cl. G08G 5/06; G06V 10/70; G06V 20/56; G08G 5/00; G08G 5/04

(52) U.S. Cl. CPC G08G 5/065; G06V 10/70; G06V 20/56; G08G 5/0021; G08G 5/0078; G08G 5/045

(57) ABSTRACT

The system includes a unit for surveying the airfield to detect, by an optical detection, one or more characteristic elements corresponding to a mandatory characteristic element corresponding to a stop marking on the ground, a taxi-holding position of a runway of the airfield, to determine a current relative position of the aircraft with respect to a taxi-holding position for which at least the mandatory characteristic element has been detected and to detect a future entry onto the runway of the airfield by the aircraft, a unit for deducing a future incursion if this future entry is not cleared and a unit for implementing an action intended to assist in avoiding, the future incursion, the system being configured to provide assistance to the aircraft pilot by improving awareness concerning a possible incursion onto a runway, by alert or ground navigation assistance messages and by providing protection via automatic braking.

### FIELD OF THE INVENTION

The present invention relates to a method and a system for assisting in the avoidance of an incursion onto a runway of an airfield by an aircraft taxiing on the airfield.

In the context of the present invention, the following definitions apply:
a runway is a traffic lane of the airfield (on which aircraft can travel), which is intended specifically for aircraft to take off and/or to land, more commonly called take-off/landing runway; and
an incursion onto a runway is an entry of an aircraft, for example of a transport airplane, travelling on an airfield, onto the runway considered, for which the aircraft has not received entry clearance from the air traffic control (ATC) authorities of the airfield.

### BACKGROUND OF THE INVENTION

It is known that transport airplanes are often equipped with a pilot information function concerning runways, of “RAAS” (for “Runway Awareness and Advisory System”) type, which is generally incorporated in a sophisticated ground proximity warning system of EGPWS (for “Enhanced Ground Proximity Warning System”) type. Such a function provides the crew of the aircraft with a better knowledge of the situation of the runway, making it possible to reduce the probability of incidents of incursion onto a runway by emitting messages (visual and audible) intended for the crew in a timely manner while taxiing on the ground. To do this, the RAAS system uses airfield data, stored in a terrain database, coupled with data from a satellite positioning system of GPS (for “Global Positioning System”) type and other standard embedded sensors, to monitor the movement of the aircraft on the airfield. The RAAS system emits visual and audible alerts at critical positions, for example on approaching a runway. However, the RAAS system does not take into account the clearance (given, directly and orally, by air traffic control to the pilot of the aircraft) to enter or not enter onto a runway that the aircraft is approaching.

### BRIEF SUMMARY OF THE INVENTION

This standard assistance system can therefore be further enhanced, notably to take into account an error or an incapacity of the pilot of the aircraft.

One aspect of the present invention may improve the assistance provided to the pilot of an aircraft to avoid an incursion onto a runway. An aspect of the present invention relates to a method for assisting in the avoidance of an incursion onto a runway of an airfield by an aircraft taxiing on the airfield.

According to an aspect of the invention, said method comprises at least the following steps:
a surveillance step, implemented by a surveillance unit, at least to survey the airfield so as to be able to detect, via an optical detection, preferably a visual detection, one or more characteristic elements comprising a mandatory characteristic element corresponding to a stop marking on the ground, said characteristic element or elements relating to a taxi-holding position of a runway of the airfield, to determine a current relative position of the aircraft with respect to a taxi-holding position for which at least the mandatory characteristic element has been detected, and to detect, if appropriate, a future entry onto said runway of the airfield by the aircraft based at least on this current relative position and parameters (speed, braking capacity, etc.) of the aircraft;
a data reception step, implemented by a data reception unit, at least for receiving at least one clearance to enter onto a runway;
a verification step, implemented by a verification unit, at least, in case of detection in the surveillance step of a future entry onto said runway, to check whether this future entry is cleared or not cleared, by taking into account the entry clearance or clearances received, if appropriate, in the data reception step, and to deduce, if this future entry is not cleared, a future incursion; and
an avoidance assistance step, implemented by at least one avoidance assistance unit, at least, in the case of a future incursion deduced in the verification step, to implemented at least one action intended to assist in avoiding (preventing) said future incursion.

Thus, the method is able notably, on the one hand, to detect, using an optical detection (specified hereinbelow) a future incursion (namely an uncleared future entry), that is to say a potential incursion, onto a runway by the aircraft (on which said method is implemented) and on the other hand to provide assistance to the pilot of the aircraft to avoid the incursion in such a situation, and do so in particular, as specified hereinbelow, by improving the awareness of the pilot regarding the actual situation (using one or more alert and/or ground navigation assistance messages) and/or by providing protection as a last resort (by implementing an automatic braking) in particular to avoid the consequences that a pilot error or incapacity could have.

The method is implemented in a taxiing phase and/or in a transition phase which, usually, is a phase between, on the one hand, a take-off phase or a landing phase and, on the other hand, such a taxiing phase. Preferably, the surveillance step comprises a data processing step implemented at least to determine at least one current alert envelope corresponding to a so-called incursion time, and dependent at least on said current relative position of the aircraft and said parameters of the aircraft, and to detect a future entry onto a runway if the current alert envelope reaches a taxi-holding position for which at least the mandatory characteristic element has been detected.

Advantageously, each alert envelope corresponds to a semicircle projected onto the ground in front of the aircraft, centered on the nose of the aircraft and having a radius calculated as a function of the corresponding predetermined incursion time, by taking into account at least the following parameters: the relative position of the aircraft with respect to the taxi-holding position considered and said parameters (speed, braking capacity, etc.) of the aircraft, and possibly a deceleration order generated on the aircraft.

Preferably, the data processing step determines a plurality of current alert envelopes, these alert envelopes corresponding to different incursion times (relating to different alert levels).

In a particular embodiment, the avoidance assistance step emits a first alert message associated with a first type of alert envelope if the corresponding current alert envelope reaches the taxi-holding position and emits, instead of this first alert message, a second alert message associated with a second type of alert envelope relating to a higher alert level if the corresponding current alert envelope reaches the taxi-holding position, the transition between emitting the first alert message and the second alert message being implemented with a hysteresis.

Advantageously, the data reception step comprises at least one of the following sub-steps:
a sub-step of manual entry of at least one clearance to enter onto a runway, by a pilot of the aircraft; and
a sub-step of automatic entry of at least one clearance to enter onto a runway.

In addition, advantageously, the data reception step comprises a sub-step of automatic detection of an on state of at least one light indicator associated with a stop marking on the ground of a taxi-holding position of a runway of the airfield.

In the context of the present invention, “optical detection” is understood to mean a detection implemented by optoelectronic means and sensors consisting in forming images from the capture of an electromagnetic radiation, for example infrared or visible. Preferably, the optical detection is a so-called visual detection, for which a visible radiation is detected.

In a preferred embodiment, the surveillance step comprises, for the implementation of the optical detection:
a sub-step of imaging (for example in the visible or in the infrared) of the environment outside of the aircraft; and
a sub-step of processing of at least some of the images taken in said imaging sub-step so as to detect, if appropriate, a characteristic element relating to a taxi-holding position, when this characteristic element is represented on at least one of the images processed.

Advantageously, the image processing sub-step implements at least one of the following techniques:
a technique using artificial intelligence;
an image processing technique.

In a preferred embodiment, said characteristic element or elements relating to a taxi-holding position comprises or comprise, in addition to the mandatory characteristic element, at least one of the following auxiliary characteristic elements:
a marking on the ground;
a light indicator;
an instruction marking or panel.

Moreover, advantageously, the surveillance step comprises a data processing step implemented at least to determine at least one current alert envelope, corresponding to a so-called incursion time and dependent at least on said current relative position of the aircraft and said parameters of the aircraft, and to detect a future entry onto a runway if the current alert envelope reaches a taxi-holding position for which at least the mandatory characteristic element has been detected.

Furthermore, advantageously, the avoidance assistance step is implemented at least to emit (in the cockpit of the aircraft) at least one of the following messages: an alert message, a ground navigation assistance message, said message being emitted in at least one of the following forms: visual, audible.

In addition, advantageously, the avoidance assistance step is implemented at least to automatically generate a braking of the aircraft, at least in case of absence of appropriate action from the pilot after the emitting of at least one message.

The present invention relates also to a system for assisting in the avoidance of an incursion onto a runway of an airfield by an aircraft taxiing on the airfield.

According to the invention, said system comprises at least:
a surveillance unit configured to survey the airfield so as to be able to detect, via an optical detection, one or more characteristic elements comprising a mandatory characteristic element corresponding to a stop marking on the ground, said characteristic element or elements relating to a taxi-holding position of a runway of the airfield, to determine a current relative position of the aircraft with respect to a taxi-holding position for which at least the mandatory characteristic element has been detected, and to detect, if appropriate, a future entry onto said runway of the airfield by the aircraft based at least on this current relative position and on parameters of the aircraft;
a data reception unit configured to receive at least one clearance to enter onto a runway;
a verification unit configured, in case of detection by the surveillance unit of a future entry onto the runway, to check whether this future entry is cleared or not cleared, by taking into account the entry clearance or clearances received, if appropriate, by the data reception unit, and to deduce, if this future entry is not cleared, a future incursion; and
at least one avoidance assistance unit configured, in the case of a future incursion deduced by the verification unit, to implement at least one action intended to assist in avoiding said future incursion.

Preferably, the surveillance unit comprises a data processing device configured at least to determine at least one current alert envelope corresponding to a so-called incursion time, and dependent at least on said current relative position of the aircraft and on said parameters of the aircraft, and to detect a future entry onto a runway if the current alert envelope reaches a taxi-holding position for which at least the mandatory characteristic element has been detected.

The present invention relates also to an aircraft, in particular a transport airplane, which comprises at least one system for assisting in avoiding an incursion onto a runway, such as that described hereinabove.

### BRIEF DESCRIPTION OF THE FIGURES

The attached figures will give a good understanding as to how the invention can be implemented. In these figures, identical references denote similar elements.

FIG. 1 is a block diagram of a system for assisting in the avoidance of an incursion onto a runway, according to a particular embodiment of the invention.

FIG. 2 is a perspective schematic view of a part of an airfield on which an aircraft equipped with a system for assisting in the avoidance of an incursion onto a runway is travelling.

FIG. 3 schematically illustrates the main steps of a method for assisting in the avoidance of an incursion onto a runway, according to a particular embodiment of the invention.

FIG. 4 is a schematic view of an aircraft seen from above, with respect to which different so-called alert envelopes have been represented.

FIG. 5 schematically shows a particular model of stop marking on the ground.

### DETAILED DESCRIPTION

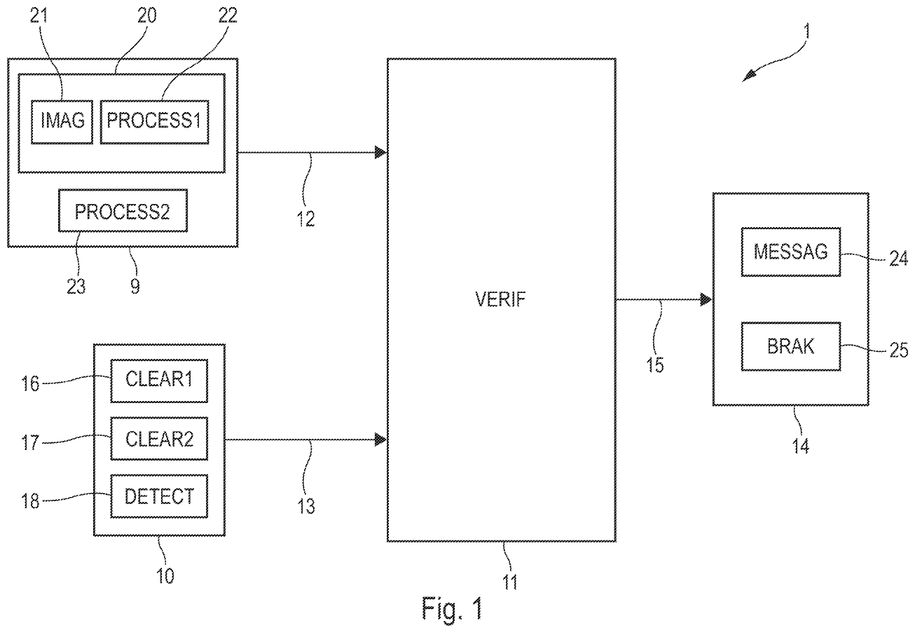

The system 1, represented schematically in FIG. 1 and making it possible to illustrate the invention, is intended to equip an aircraft AC, in particular a transport airplane.

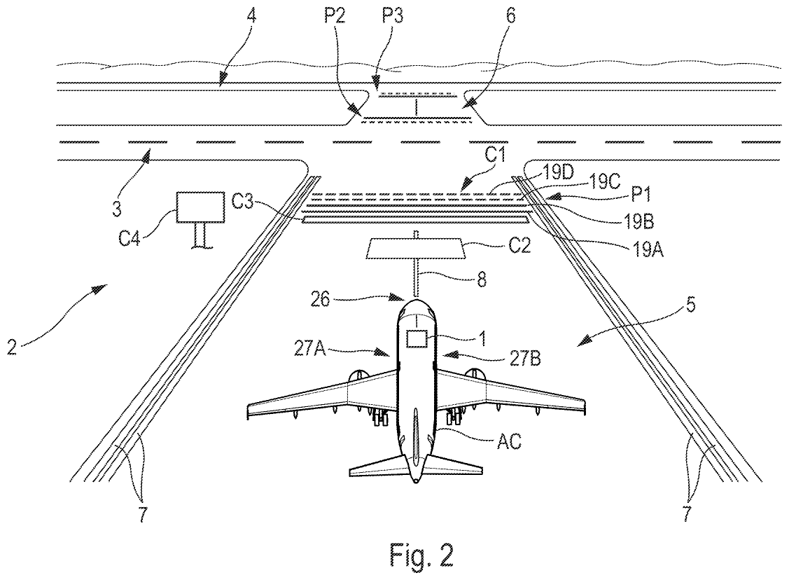

This system 1 (which is embedded on the aircraft AC, as represented very schematically in FIG. 2 and FIG. 4) is intended to assist the aircraft AC, when it is taxiing on an airfield 2, as in the example of FIG. 2, in avoiding an incursion onto a (landing and/or take-off) runway 3, 4 of the airfield 2, that is to say in avoiding an uncleared entry onto a (landing and/or take-off) runway 3, 4.

As represented by way of illustration in FIG. 2, the airfield 2 comprises traffic lanes comprising notably:
the runways 3 and 4 intended for aircraft to take off and/or to land; and
taxiways 5 and 6 allowing an aircraft to travel on the airfield 2, notably to take the path (by taxiing) between the runway 3, 4 used for take-off or landing and a parking zone (not represented).

In the example of FIG. 2, the aircraft AC is taxiing on the taxiway 5 to the runway 3. The taxiway 5 is delimited laterally, on either side, by double lane edge lines 7, for example in yellow, and it comprises a centerline 8, for example also in yellow.

The system 1 which is active during the taxiing and transition phases (specified hereinbelow) comprises, as represented in FIG. 1:
a surveillance unit 9 configured:
to survey the airfield 2 so as to be able to detect, via a so-called optical detection (and notably a visual detection), at least one characteristic element Cn (n being an integer) relating to a taxi-holding position P1 (i being an integer) of a runway 3, 4 of the airfield 2 including at least one mandatory characteristic element C1 specified hereinbelow. Usually, a taxi-holding position P1 is a point of a taxiway 5, 6 at which the aircraft AC waits (stops) before entering into an adjacent runway 3, 4, as illustrated for the taxi-holding positions P1, P2 and P3 in FIG. 2;
to determine a current relative position of the aircraft AC (equipped with the system 1) with respect to the taxi-holding position P1 for which a characteristic element Cn has been detected; and
to detect, if appropriate, a future entry (or potential entry, that is to say an entry which will take place if, notably, the current taxiing conditions of the aircraft AC are maintained) onto said runway 3, 4 of the airfield 2 by the aircraft AC, based on this duly determined current relative position and on parameters (speed, braking capacity, etc.) of the aircraft AC;
a data reception unit 10 configured to allow the system 1 to receive at least one clearance to enter onto a runway 3, 4;
a verification unit 11 (VERIF for “Verification unit”) configured, in case of detection by the surveillance unit 9 (to which it is linked via a link 12) of a future entry onto a runway, to check whether this future entry is cleared or not cleared, by taking into account the entry clearance or clearances received, if appropriate, by the data reception unit 10 (to which it is linked via a link 13), and to deduce, in the case where this future entry detected is not cleared, a future incursion (or uncleared potential entry, that is to say an uncleared entry which will take place if, notably, the current taxiing conditions of the aircraft AC are maintained); and
an avoidance assistance unit 14, linked via a link 15 to the verification unit 11 and configured, in the case of a future incursion deduced by the verification unit 11, to implement at least one action intended to assist in avoiding (that is to say preventing) said future incursion, as specified hereinbelow.

The data reception unit 10 comprises at least one of the following elements:
a manual entry (or input) element 16 (CLEAR1 for “manual Clearance entry device”) configured to allow a pilot of the aircraft AC to manually enter into the system 1 a clearance to enter onto a runway, that air traffic control has communicated to him or her. The manual entry element 16 can correspond to any element allowing the pilot to enter data into the system 1, such as, for example, a keyboard associated with a screen, a touchpad, a touchscreen, etc.; and
an automatic entry element 17 (CLEAR2 for “automatic Clearance entry device”) configured to automatically enter into the system 1 a clearance to enter onto a runway, as specified hereinbelow.

Usually, such a clearance to enter onto a runway is granted by air traffic control of the airfield 2, and it is generally transmitted via a voice message to the pilot of the aircraft AC.

In addition, in a particular embodiment, the data reception unit 10 also comprises an automatic detection element 18 (DETECT for “automatic Detection device”). This automatic detection element 18 is configured to automatically detect an on state of at least one light indicator relating to a taxi-holding position of a runway of the airfield 2, as specified hereinbelow.

Moreover, in a preferred embodiment, the surveillance unit 9 comprises an optical detection system 20, preferably a visual detection system.

This optical detection system 20 comprises, as represented in FIG. 1:
an imaging device 21 (IMAG for “Imaging device”) configured to take images of the environment outside of the aircraft AC; and
an image processing device 22 (PROCESS1 for “image Processing device”) configured to process at least some of the images taken by the imaging device 21 so as to detect, if appropriate, a characteristic element Cn (specified hereinbelow) relating to a taxi-holding position P1, when this characteristic element Cn is represented in at least one of the images processed (that is to say of which there is a representation in the image).

Preferably, the imaging device 21 takes images in the visible and the system 20 then corresponds to a visual detection system. In a variant, it can also take images from radiations exhibiting other wavelengths, for example in the infrared.

Furthermore, the image processing device 22 implements at least one of the following techniques, specified hereinbelow:
a technique using artificial intelligence;
an image processing technique.

Moreover, the surveillance unit 9 also comprises a data processing device 23 (PROCESS2 for “data Processing device”) configured to perform various processing operations and computations specified hereinbelow.

In a particular embodiment, the data processing device 23 is configured to:
determine at least one alert envelope, representative of a so-called incursion time and dependent at least on said current relative position of the aircraft AC and on parameters of the aircraft AC; and
detect a future entry onto a runway if the alert envelope reaches the taxi-holding position P1 (for which a characteristic element Cn has been detected).

Furthermore, the avoidance assistance unit 14 comprises a message emitting device 24 (MESSAG for “Message emitting device”). The message emitting device 24 is configured to emit in the cockpit of the aircraft AC, to the pilot or pilots of the aircraft AC, an alert message and/or a ground navigation assistance message. The message emitting device 24 emits the message or messages in visual form and/or in audible form and/or in any other form, such as, for example, a mechanical stimulation in the seat of the pilot.

In addition, the avoidance assistance unit 14 also comprises a braking device 25 (BRAK for “Braking device”) configured to automatically generate a braking of the aircraft AC, in case of absence of appropriate action from the pilot after the emission of an alert message by the message emitting device 24.

Thus, as will be described in more detail hereinbelow, the system 1 is able, on the one hand, to detect a future incursion (that is to say an uncleared future entry) onto a runway 3 by the aircraft AC equipped with the system 1, and on the other hand to provide assistance to the pilot of the aircraft AC to avoid the incursion in such a situation, and do so in particular, as also specified hereinbelow, by improving the awareness of the pilot regarding the actual situation (by alert and/or ground navigation assistance messages, emitted by the message emitting device 24) and/or by providing protection (or safety) as a last resort or last recourse (by an automatic braking implemented by the braking device 25) notably in case of pilot error or incapacity.

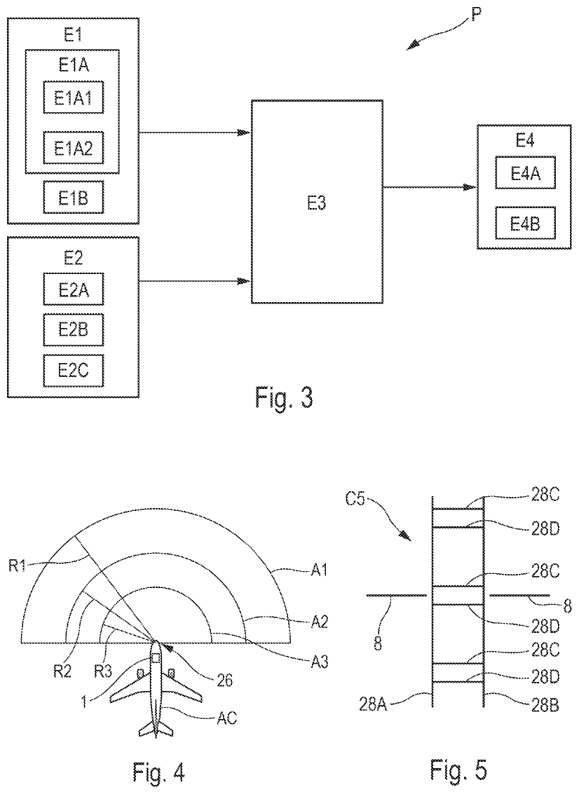

The system 1, as described above, is intended to implement a method P for assisting in the avoidance of an incursion onto a runway of an airfield 2 by an aircraft AC taxiing on the airfield 2 (FIG. 2), as presented hereinbelow with reference to FIG. 3.

The method P comprises the following steps:
a surveillance step E1, implemented by the surveillance unit 9, at least to survey the airfield 2 so as to be able to detect, via an optical detection, at least one characteristic element Cn (including the mandatory characteristic element C1 specified hereinbelow) relating to a taxi-holding position P1 of a runway 3, 4 of the airfield 2. The surveillance step E1 is also implemented to determine a current relative position of the aircraft AC with respect to a taxi-holding position P1 for which the mandatory characteristic element C1 has been detected, and to detect, if appropriate, a future entry onto said runway 3, 4 of the airfield 2 by the aircraft AC based notably on this current relative position;
a data reception step E2, implemented by the data reception unit 10, at least to receive at least one clearance to enter onto a runway 3, 4;
a verification step E3, implemented by the verification unit 11, at least (in case of detection in the surveillance step E1 of a future entry onto a runway 3, 4) to check whether this future entry is cleared or not cleared. For this, the verification step E3 takes into account the entry clearance or clearances received, if appropriate, in the data reception step E2. The verification step E3 deduces a future incursion if this future entry is not cleared; and
an avoidance assistance step E4, implemented by the avoidance assistance unit 14, at least (in the case of a future incursion deduced in the verification step E3) to implement at least one action intended to assist in avoiding (that is to say preventing) said future incursion.

The surveillance step E1 and the data reception step E2 are implemented continuously, when the system 1 is active and the method P is implemented, and as long as that remains the case.

As for the verification step E3, it is only implemented when a future entry onto a runway 3, 4 has been detected in the surveillance step E1.

Similarly, the avoidance assistance step E4 is only implemented when a future incursion has been deduced in the verification step E3.

The system 1 is activated and the method P is implemented as soon as (and only when) the aircraft AC is in a taxiing phase or in a transition phase. A transition phase is, usually, a phase of movement on the ground between, on the one hand, a take-off phase or a landing phase, and, on the other hand, such a taxiing phase.

This activation (of the system 1 for the implementation of the method P) is performed automatically, the system 1 having knowledge, automatically and in the normal manner, of the implementation of a taxiing phase or of a transition phase.

The system 1 is deactivated at the end of the taxiing phase and/or of the transition phase. This deactivation is performed either automatically or manually by the pilot by actuating a deactivation element (not represented) of the system 1.

As indicated above, the characteristic elements Cn relating to a taxi-holding position P1 comprise at least one mandatory characteristic element C1. This mandatory characteristic element C1 is a stop marking on the ground. It conforms to a standard model A (or “pattern A”) of a marking on the ground. This model A is therefore mandatory for all the runways such as the runways 3 and 4. Usually, it is formed by a set comprising two straight segments 19A and 19B and two rows 19C and 19D of broken lines, parallel to one another and orthogonal to the centerline of the runway considered (such as the centerline 8 for example), as represented by way of illustration in FIG. 2 for the runway 3.

Since this stop marking on the ground (characteristic element C1) is mandatory for all airfields, it is prioritized in the implementation of the present invention to detect a risk of incursion onto a runway.

It is also known that there can also be, at certain taxi-holding positions P1, a standard model B (“pattern B”) of stop marking on the ground, which can also be used as characteristic element by the system 1, such as the characteristic element C5 represented by way of illustration in FIG. 5. This model B complements the model A and is further away from the runway. It is used in a precision approach in order to avoid any interference with an ILS (for “Instrument Landing System”) signal for an instrument landing. Usually, the characteristic element C5 is formed by a set comprising two straight segments 28A and 28B that are parallel to one another and orthogonal to the centerline of the runway considered (such as the centerline 8 for example), and a plurality of pairs of two straight segments 28C and 28D that are parallel to the centerline and link together the straight segments 28A and 28B, as represented in FIG. 5.

In a preferred embodiment, said characteristic element or elements Cn relating to a taxi-holding position P1 also comprise at least one of the following auxiliary characteristic elements, as represented in FIG. 2 for the taxi-holding position P1:
an auxiliary marking C2 on the ground before the taxi-holding position P1;
a light indicator C3 associated with the stop marking on the ground (mandatory characteristic element C1) of the taxi-holding position P1;
a marking (on the ground) of instructions or a panel of instructions C4 of the taxi-holding position P1.

FIG. 2 also represents, by way of illustration:
a taxi-holding position P2 intended for an aircraft taxiing on the taxiway 6 before entering onto the runway 3; and
a taxi-holding position P3 intended for an aircraft taxiing on the taxiway 6 before entering onto the runway 4.

A marking on the ground, such as the marking C2, optional and additional, can also be present before the taxi-holding position and be detected in the implementation of the method P. This marking C2 can comprise information such as the following “RUNWAY AHEAD” or “RWY AHEAD”.

Moreover, the light indicators C3 (capable of emitting a light, generally red, when they are on) provide visual information on the clearance from air traffic control to enter or not enter onto the associated runway 3. They are positioned at the taxi-holding position P1 of the associated runway 3 and operate as follows:
when the light indicator or indicators C3 is/are on (emitting a red light), the aircraft AC does not have clearance to enter onto the runway 3; and
when the light indicator or indicators C3 is/are off, the aircraft AC has clearance to enter onto the runway 3.

The light indicators, such as the light indicator C3, at the taxi-holding positions are not however mandatory on all airfields.

Consequently, the absence of a light indicator that is on provides no indication as to a potential situation of incursion onto the runway. On the other hand, the detection of a light indicator that is on confirms the absence of a clearance from air-traffic control to enter onto (penetrate) the associated runway.

The on state (red light) of a light indicator C3 is detected by the automatic detection element 18 of the system 1 via a visual detection.

In a preferred embodiment, the automatic detection element 18 corresponds to the optical detection unit 20, and the optical (visual) detection of the light indicator C3 is implemented by this optical detection unit 20 (preferably in the manner described hereinbelow with reference to the optical detection step E1A).

Moreover, the stop point instruction panels, such as the instruction panel C4 of FIG. 2, which comprise an indication relating to the runway, are mandatory on all airfields.

The presence of this type of characteristic elements can therefore be a confirmation of the presence of a taxi-holding position. In addition, the indication on the instruction panel can also provide information on the designation of the runway and the location of the taxi-holding position. Such additional information can be useful to confirm that the aircraft is indeed approaching the runway 3 considered.

In cases where it is impossible to install a mandatory instruction panel, the instructions are presented in the form of a marking on the ground. Such marking instructions on the ground are also recommended (but not mandatory) as redundancy for the mandatory instruction panels.

The clearance to enter onto a runway, given by air traffic control (ATC, must be known by the system 1 (and in particular by the verification unit 11) to know if the aircraft AC is cleared or not cleared to enter onto a runway. This clearance can be recovered by the system 1 in different ways, in the data reception step E2.

For this, the data reception step E2 comprises, first of all, a manual entry sub-step E2A, during which the pilot of the aircraft manually enters (inserts) a clearance (to enter onto a runway), in the system 1, using the manual entry (or input) element 16. The pilot enters the clearance when it has been communicated to him or her by air traffic control on approaching the runway considered.

In a variant or in addition to the sub-step E2A, the data reception step E2 comprises an automatic entry sub-step E2B, implemented by the automatic entry element 17, to automatically enter a clearance (to enter onto a runway), in the system 1.

In the sub-step E2B, in a preferred embodiment, a clearance from air traffic control, emitted via a voice message intended for the pilot, is recovered automatically by the automatic entry element 17.

For this, in a preferred embodiment, the automatic entry element 17 comprises, to automatically recover such a clearance:
at least one standard voice transcription algorithm (of STT type, for “Speech To Text”), based on artificial intelligence. This voice transcription algorithm receives and processes the communications incoming from air traffic control intended for the pilot, and transcribes, in the normal manner, each voice message from an air traffic controller into a text message; and
at least one standard information extraction algorithm, also based on artificial intelligence. This information extraction algorithm processes, in the normal manner, the text messages (from air traffic control) generated by the voice transcription algorithm, to extract therefrom the information on clearance to enter onto a runway. The duly extracted clearance information is then communicated to the verification unit 11 via the link 13.

In a variant embodiment, in the sub-step E2B, the automatic entry element 17 can also comprise a data transmission link, via which a clearance is transmitted (preferably automatically) to the system 1 (and notably to the verification unit 11), for example either directly from an air traffic control system, or from a system of the aircraft which has this information.

In a variant or, preferably, in addition to the sub-steps E2A and E2B, the data reception step E2 can also comprise an automatic detection sub-step E2C. This automatic detection sub-step E2C is implemented by the automatic detection element 18 (FIG. 1) in order to detect an on state (red light) of a light indicator C3 (FIG. 2) of a taxi-holding position P1 of a runway 3 of the airfield 2. As indicated above, the detection of a light indicator C3 that is on confirms the absence of a clearance from air traffic control to enter onto the associated runway 2. On the other hand, the absence of detection of a light indicator C3 that is on provides no indication as to a possible clearance to enter onto the associated runway 2.

Moreover, in a preferred embodiment, the surveillance step E1 comprises an optical detection step E1A. This optical detection step E1A comprises:
an imaging sub-step E1A1, implemented by the imaging device 21, to take images of the environment outside of the aircraft AC; and
an image processing sub-step E1A2, implemented by the image processing device 22, to process at least some of the images taken in said imaging sub-step E1A1 so as to detect, if appropriate, a characteristic element relating to a taxi-holding position, when this characteristic element is represented in at least one of the images processed.

The optical detection step E1 is implemented to detect all the characteristic (visual) elements which are situated at the taxi-holding position.

To implement this optical detection, the aircraft AC is equipped with one or more imaging devices 21, namely, preferably, cameras, for taking (or capturing) the images of the outside environment (in the imaging sub-step E1A1) while the aircraft AC is taxiing and provide the image processing device 22 with the images captured.

The cameras can be arranged at various points on the aircraft AC where they capture the scene in front of the aircraft AC with a visual field that is sufficient to detect the characteristic elements, regardless of the trajectory of the aircraft AC on approaching a taxi-holding position P1 (namely in a straight line or along a curved trajectory in the case where the traffic lane comprises a turn before reaching the taxi-holding position).

Preferably, the most appropriate locations are the ventral fairing (not visible in the figures) of the aircraft AC, the nose 26 of the aircraft AC and the sides 27A and 27B (left and right) of the fuselage of the aircraft AC, as illustrated in FIG. 2.

In a first variant embodiment, the image processing sub-step E1A2 implements a technique using artificial intelligence.

In this first variant, one or more artificial intelligence algorithms incorporated in the image processing device 22 use an image as input, and, if appropriate, detect and locate a representation of the characteristic element in the image. Different artificial intelligence approaches can be used, including “machine learning” and/or “deep learning” techniques.

In a preferred embodiment, in which the image processing device 22 is based on artificial intelligence using a machine learning system, the machine learning system uses, for the learning, data collected previously which are representative of a variety of situations and situations conforming to those which can be encountered by an aircraft travelling on an airfield. For this, cameras are installed on one or more aircraft. These cameras are identical to those used by the system 1 or at the very least have technical characteristics close to those used by the system 1. In addition, these cameras are installed on this aircraft or these aircraft at the same locations as, or at locations that are as close as possible to, those of the cameras of the system 1. Images are taken when one or more duly equipped aircraft is/are taxiing on airfields, and the images taken are stored. All of the stored images are then collected. The imagings are performed on different airfields, for different and varied brightness conditions (for example daytime, nighttime, etc.) and different and varied weather conditions (sunny weather, rain, snow, etc.) so as to take into account all of the main situations and conditions likely to be encountered by an aircraft equipped with the system 1. All of the images thus collected are used by the artificial intelligence learning system of the image processing device 22.

Different artificial intelligence-based processing techniques can provide the information that is sought. Examples that can be cited by way of illustration include:
an object detection. In this case, if a characteristic element is represented in the image, the artificial intelligence algorithm detects it and locates it spatially in the image. These operations can be performed by taking into account notably the geometry, the color, the symmetry, etc., with standard and automatic learning algorithms, or be implemented fully by a deep learning algorithm which is previously trained in order to find the best characteristics for detecting the objects
a segmentation of the image. In this case, each pixel of the image is classed as forming part or not forming part of a characteristic element, and if a characteristic element is represented in the image, the set of the pixels relating to this characteristic element makes it possible to detect it and locate it.

Such an artificial intelligence-based approach can also recover the text information from taxi-holding position instruction panels, such as the instruction panel C4 of FIG. 2, to provide the system 1 with the information on the designation of the runway and the location of the taxi-holding position.

In a second variant embodiment, the image processing sub-step E1A2 implements a so-called image processing technique.

It is known that the image processing techniques process the pixels of the image, by using filters and the usual signal processing techniques, to recover points of interest and geometric information in the image in order to check whether a characteristic element is represented in the image, and, if appropriate, locate it spatially in the image.

By thus knowing the position of the representation of the characteristic element in the image (by virtue of the image processing implemented in the image processing sub-step E1A2), and by taking into account calibration characteristics of the imaging device 21, notably a camera, used to capture the image processed, the system 1 and for example the data processing device 23 can determine, in the usual manner, the relative position of the aircraft with respect to the characteristic element detected, and thus with respect to the associated taxi-holding position. As calibration characteristics of the imaging device 21, the system 1 notably uses the position and the orientation of the imaging device 21 on the aircraft and imaging parameters (aperture, resolution, etc.) of the imaging device 21.

Furthermore, in a third variant embodiment, the image processing sub-step E1A2 implements both a technique (such as that described hereinabove) using artificial intelligence and an image processing technique (such as that also described hereinabove).

At each imaging instant considered, the camera or cameras takes/take a new image which is then processed. Thus, a trajectory of the aircraft is obtained by the taking into account of the successive positions of the aircraft with respect to the characteristic element.

Moreover, the surveillance step E1 comprises a data processing step E1B implemented by the data processing device 23.

The data processing step E1B preferably performs a consolidation of the relative position of the aircraft with respect to the taxi-holding position, from, if appropriate, the detection of several characteristic elements relating to this taxi-holding position.

The data processing step E1B, implemented by the data processing device 23, also comprises the following operations:
determining a current alert envelope dependent at least on the current relative position of the aircraft AC, as determined previously, and parameters of the aircraft specified hereinbelow; and
detecting a future entry onto the runway if the taxi-holding position (as detected) penetrates into the current alert envelope.

In a particular embodiment, three alert (or safety) levels are provided, namely, in order of triggering of the alert in the event of occurrence of an incursion onto a runway:
an indication (“advisory”) which is optional;
a caution; and
an alarm (“warning”).

An alert (or safety) envelope A1, A2, A3 is determined for each of the alert levels considered. More specifically, in the above-mentioned particular embodiment, as represented in FIG. 4:
the alert envelope A1 is determined for the indication;
the alert envelope A2 is determined for the caution;
the alert envelope A3 is determined for the alarm.

In case of absence of clearance to enter onto a runway, when the taxi-holding position detected enters into one of these different alert envelopes A1, A2, A3, the corresponding alert is triggered, as specified hereinbelow.

In a preferred embodiment, represented in FIG. 4, each alert envelope A1, A2, A3 corresponds to a semicircle projected onto the ground, in front of the aircraft AC. Each alert envelope A1, A2, A3 is centered on the nose 26 of the aircraft AC and has a particular radius R1, R2, R3. This radius R1, R2, R3 represents the relative distance between the nose 26 of the aircraft AC and a taxi-holding position from which the corresponding alert will be triggered (in the absence of clearance to enter onto the corresponding runway).

The radius R1, R2, R3 is calculated as a function of a so-called incursion time. The incursion time is a predetermined time. It corresponds to the time that the aircraft is allowed to reach the taxi-holding position before triggering the corresponding alert. It varies according to the alert level. More specifically, the higher the alert level (that is to say with a danger becoming more imminent), the lower the incursion time as represented in FIG. 4 for the corresponding radii R1, R2 and R3. As a nonlimiting illustration, it may for example be 3 or 4 seconds for the radius R3, 6 to 8 seconds for the radius R2, and 12 to 15 seconds for the radius R1.

The radius R3 is calculated (by the data processing device 23) as a function of the corresponding predetermined incursion time, by taking into account the following parameters comprising parameters of the aircraft AC:
the relative position of the aircraft AC with respect to the taxi-holding position considered;
parameters (speed, braking capacities) of the aircraft AC; and
a possible deceleration order generated on the aircraft AC.

As for the radii R2 and R1, they are calculated from the radius R3 by taking into account, each time, a corresponding predetermined pilot reaction and decision time.

Moreover, as indicated hereinabove, the verification step E3, implemented by the verification unit 11, provides (in case of detection in the surveillance step E1 of a future entry onto a runway 3, 4) for checking whether this future entry is cleared or not cleared. For this, the verification step E3 takes into account the entry clearance or clearances received, if appropriate, in the data reception step E2. The verification step E3 deduces a future incursion if this future entry is not cleared.

Finally, the avoidance assistance step E4, implemented by the avoidance assistance unit 14, performs (in the case of a future incursion deduced in the verification step E3) at least one action intended to assist in avoiding (that is to say in preventing) this future incursion.

For this, the avoidance assistance step E4 comprises, generally, first of all, a sub-step E4A of emission of one or more messages intended for the pilot in the cockpit of the aircraft AC. The message or messages emitted can be one or more alert messages (alerting the pilot simply to the situation) and/or one or more ground navigation assistance messages (giving indications or instructions to the pilot to remedy the risk of incursion, for example by asking the pilot to perform a braking of the aircraft AC).

The message emitting device 24 emits this message or these messages
in visual form, for example by displaying a message or a symbol on a screen of the cockpit, notably via a standard display of “head-up” type, or by emitting a light signal;
and/or
in audible form, for example using a loudspeaker and/or a siren installed in the cockpit.

In a particular embodiment, in the case where the clearance has been entered into the system 1 (from an entry of the pilot or an automatic recovery) but a light indicator is on (thus not clearing the entry onto the runway), the alert message is adapted in order for the pilot to understand why the system 1 is triggering the incursion alert.

Obviously, if, after the emission of an alert message in the avoidance assistance step E4, a clearance (to enter onto the runway) is supplied to the system 1, the corresponding alert is lifted and the alert messages no longer emitted.

Each alert message emitted depends on the alert level considered, out of the possible alert levels, and notably out of the three alert levels described hereinabove. As an illustration, for these three alert levels, the message emitting device 24 can emit the following messages:
for an indication (“advisory”), a visual message;
for a caution, visual and audible messages; and
for an alarm (“warning”), visual and audible messages. In addition, if necessary, an automatic braking sub-step E4B is triggered.

Preferably, for these three alert levels, the message emitting device 24 emits the following messages:
the message relating to an indication (“advisory”), from the moment the taxi-holding position detected enters into the alert envelope A1 (relating to an incursion time lying, for example, between 12 and 15 seconds) and does so until the moment when the taxi-holding position detected enters into the alert envelope A2 (or re-emerges from the alert envelope A1);
the message or messages relating to a caution, from the moment the taxi-holding position detected enters into the alert envelope A2 (relating to an incursion time lying, for example, between 6 and 8 seconds) and does so until the moment when the taxi-holding position detected enters into the alert envelope A3 (or re-emerges from the alert envelope A2); and
the message or messages relating to an alarm (“warning”), from the moment the taxi-holding position detected enters into the alert envelope A3 (relating to an incursion time lying, for example, between 3 and 4 seconds) and as long as it remains within this alert envelope A3.

Since the alert message emitted is, each time, adapted to the current situation, possible transitions from one alert message to another alert message can take place over time.

Preferably, the system 1 applies a hysteresis to the transition from the emission of a first alert message to the emission of a second alert message to avoid any excessively dynamic change and therefore appearances and disappearances of alert messages, potentially a nuisance for the pilot. For example, if the transition from a first alert message (for example relating to an indication or to a caution) to a second alert message (for example relating to a caution or to a warning) regarding an alert level that is higher than the first alert message is implemented for an incursion time t0, the return, that is to say the subsequent transition from the second alert message to the first alert message, will be implemented for an incursion time t1 that is higher than this incursion time t0.

Moreover, in a particular embodiment, when the pilot performs a braking (which generally is not linear and perfect) of the aircraft, the system 1 checks whether the braking is sufficient to stop the aircraft before a runway incursion. If the braking is sufficient, no alert message is emitted. On the other hand, if the braking is insufficient or if the pilot stops his or her braking, the actions required by the situation are implemented (emission of alert message and/or automatic braking).

The sub-step E4B performs an automatic braking of the aircraft, which is implemented by the braking device 25. For this, in a particular embodiment, the braking device 25 automatically sends a braking order to a standard braking system of the aircraft AC, and does so preferably until the aircraft AC is completely stopped.

Consequently, if, following indication, caution and warning alerts, the pilot does not take the appropriate measures, the system 1 triggers a recovery action, namely an appropriate automatic braking order is calculated and supplied to the braking system of the aircraft AC to stop it and thus prevent an incursion onto the runway.

This sub-step E4B therefore automatically generates a braking of the aircraft, and does so in the case of absence of appropriate action from the pilot after the emission of messages. This sub-step E4B implements a protection as a last resort and notably makes it possible to avoid the consequences that an error or an incapacity of the pilot could have.

In a particular case, if the necessary conditions are fulfilled, this sub-step E4B can be implemented even if the sub-step E4A has not previously been implemented.

The system 1 and the method P, as described hereinabove, offer numerous advantages. In particular:
they are able to automatically detect a future incursion or potential incursion (that is to say an uncleared future entry) onto a runway by the aircraft equipped with the system 1;
they are able to provide an assistance to the pilot of the aircraft to avoid the incursion in such a situation;
this assistance consists, first of all, in making the pilot aware of the actual situation (using one or more alert and/or ground navigation assistance messages);
this assistance notably makes it possible to provide the pilot with an alert level that is relevant based on a predetermined incursion time;
this assistance also comprises a protection, as a last resort or a last recourse (by implementing an automatic braking), in particular to mitigate a pilot error or incapacity; and
the processing operations implemented, notably concerning the optical detection, can use artificial intelligence techniques and are particularly accurate.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for assisting in the avoidance of an incursion onto a runway of an airfield by an aircraft taxiing on the airfield, said method comprising:
a surveillance step (E1), implemented by a surveillance unit, at least to survey the airfield so as to be able to detect, via an optical detection, one or more characteristic elements comprising a mandatory characteristic element corresponding to a stop marking on the ground, said characteristic element or elements relating to a taxi-holding position of a runway of the airfield, to determine a current relative position of the aircraft with respect to a taxi-holding position for which at least the mandatory characteristic element has been detected, and to detect, if appropriate, a future entry onto said runway of the airfield by the aircraft based at least on the current relative position and on parameters of the aircraft, the surveillance step (E1) comprising a data processing step (E1B) implemented at least to determine at least one current alert envelope corresponding to a so-called incursion time, and depending at least on said current relative position of the aircraft and said parameters of the aircraft, and to detect a future entry onto a runway if the current alert envelope reaches a taxi-holding position for which at least the mandatory characteristic element has been detected;
a data reception step (E2), implemented by a data reception unit, at least to receive at least one clearance to enter onto a runway;
a verification step (E3), implemented by a verification unit, at least, in case of detection in the surveillance step (E1) of a future entry onto the runway, to verify if the future entry is cleared or not cleared, by taking into account the entry clearance or clearances received, if appropriate, in the data reception step (E2), and to deduce, if the future entry is not cleared, a future incursion; and
an avoidance assistance step (E4), implemented by at least one avoidance assistance unit, at least, in the case of a future incursion deduced in the verification step (E3), to implement at least one action intended to assist in avoiding said future incursion.

2. The method as claimed in claim 1,
wherein the data reception step (E2) comprises at least one of:
a sub-step (E2A) of manual entry of at least one clearance to enter onto a runway, by a pilot of the aircraft (AC); or
a sub-step (E2B) of automatic entry of at least one clearance to enter onto a runway.

3. The method as claimed in claim 1,
wherein the data reception step (E2) comprises a sub-step (E2C) of automatic detection of an on state of at least one light indicator associated with a stop marking on the ground of a taxi-holding position of a runway of the airfield.

4. The method as claimed in claim 1,
wherein the surveillance step (E1) comprises, for the implementation of the optical detection:
a sub-step (E1A1) of imaging of the environment outside of the aircraft; and
a sub-step (E1A2) of processing of at least one of the images taken in said imaging sub-step (E1A1) so as to detect, if appropriate, a characteristic element relating to a taxi-holding position, when the characteristic element is represented in at least one of the images processed.

5. The method as claimed in claim 4,
wherein the image processing sub-step (E1A2) implements at least one of the following techniques:
a technique using artificial intelligence; or
an image processing technique.

6. The method as claimed in claim 1,
wherein said characteristic element or elements relating to a taxi-holding position comprise, in addition to the mandatory characteristic element, at least one of the following auxiliary characteristic elements:
a marking on the ground;
a light indicator; or
an instruction marking or panel.

7. The method as claimed in claim 1,
wherein each alert envelope corresponds to a semicircle projected onto the ground in front of the aircraft, centered on the nose of the aircraft and having a radius calculated as a function of the corresponding predetermined incursion time, by taking into account at least the following: the relative position of the aircraft with respect to the taxi-holding position considered and said parameters of the aircraft.

8. The method as claimed in claim 1,
wherein the data processing step (E1B) determines a plurality of current alert envelopes, the current alert envelopes corresponding to different incursion times.

9. The method as claimed in claim 8,
wherein the avoidance assistance step (E4) emits a first alert message associated with a first type of alert envelope if the corresponding current alert envelope reaches the taxi-holding position and emits, instead of the first alert message, a second alert message associated with a second type of alert envelope relating to a higher alert level if the corresponding current alert envelope reaches the taxi-holding position, the transition of the emitting between the first alert message and the second alert message is implemented with a hysteresis.

10. The method as claimed in claim 1,
wherein the avoidance assistance step (E4) is implemented at least to emit at least one of the following messages: an alert message, or a ground navigation assistance message, said message being emitted in at least one of the following forms: visual, or audible.

11. The method as claimed in claim 1,
wherein the avoidance assistance step (E4) is implemented at least to automatically generate a braking of the aircraft, at least in case of absence of appropriate action from the pilot after the emitting of at least one message.

12. A system for assisting in the avoidance of an incursion onto a runway of an airfield by an aircraft taxiing on the airfield, the system comprises:
a surveillance unit configured to survey the airfield so as to be able to detect, via an optical detection, one or more characteristic elements comprising a mandatory characteristic element corresponding to a stop marking on the ground, said characteristic element or elements relating to a taxi-holding position of a runway of the airfield, to determine a current relative position of the aircraft with respect to a taxi-holding position for which at least the mandatory characteristic element has been detected, and to detect, if appropriate, a future entry onto said runway of the airfield by the aircraft based at least on the current relative position and on parameters of the aircraft, the surveillance unit comprising a data processing device configured at least to determine at least one current alert envelope corresponding to a so-called incursion time and dependent at least on said current relative position of the aircraft and on said parameters of the aircraft, and to detect a future entry onto a runway if the current alert envelope reaches a taxi-holding position for which at least the mandatory characteristic element has been detected;
a data reception unit configured to receive at least one clearance to enter onto a runway;
a verification unit, configured, in case of detection by the surveillance unit of a future entry onto the runway, to verify if the future entry is cleared or not cleared, by taking into account the entry clearance or clearances received, if appropriate, by the data reception unit, and to deduce, if the future entry is not cleared, a future incursion; and
at least one avoidance assistance unit configured, in the case of a future incursion deduced by the verification unit, to implement at least one action intended to assist in avoiding said future incursion.

13. An aircraft comprising:
at least one system as claimed in claim 12.
